(19) United States
(12) Patent Application Publication
(10) Pub. No.: US 2013/0110605 A1
(43) Pub. Date: May 2, 2013

(54) PRODUCT RECOGNITION PROMOTIONAL OFFER MATCHING

(71) Applicant: Glenn Grossman, Matthews, NC (US)

(72) Inventor: Glenn Grossman, Matthews, NC (US)

(73) Assignee: BANK OF AMERICA CORPORATION, Charlotte, NC (US)

(21) Appl. No.: 13/342,087

(22) Filed: Jan. 1, 2012

Related U.S. Application Data
(60) Provisional application No. 61/553,233, filed on Oct. 30, 2011.

(51) Int. Cl. G06Q 30/02

(52) U.S. Cl. 705/14.25; 705/14.55; 705/14.54; 705/14.53

(57) ABSTRACT

Embodiments of the invention are directed to a system, method, or computer program product for matching available promotional offers to products identified by a user. Embodiments of the invention allow a user to receive offers for products based on the user's identification of a product that he/she would like to receive an offer for. The user may provide identification of a product by providing an image, a video, keywords, or the code associated with the product of interest to the system. In this way, the system may find and provide the user with offers for products that he/she are interested in purchasing, instead of having to find offers he/she is interested in by searching the offers available to him/her. Furthermore, the user may receive one or more available offers for a product that he/she identifies as a product he/she wishes to receive an offer for.

### CLAIM OF PRIORITY UNDER 35 U.S.C. §119

This Non-provisional patent application claims priority to Provisional Patent Application Ser. No. 61/553,233 titled “Product Recognition Promotional Offer Matching” filed Oct. 30, 2011, assigned to the assignee hereof and hereby expressly incorporated by reference herein.

### BACKGROUND

Many factors may play a role in an individual's selection of a particular product. The individual's perception of the brand, advertisement of a product, advertisement of a brand, promotional offers for a product, etc., may all have a direct correlation with which products an individual may select to purchase. In most instances an individual's prior use of a particular product or a particular brand of product plays the largest role in the selection of a particular product. For example, if the individual is selecting a laundry detergent at a retail store, the retail store typically has an ample selection of laundry detergents for the individual to choose from. The individual may select a particular laundry detergent that he/she historically selected when he/she has previously purchased laundry detergent, without giving serious consideration to other detergent choices available.

As discussed above, promotional offers for products may also influence an individual's selection of on a product or brand of product. Promotional offers for a product may include discounts, coupons, rewards, and/or the like. These offers may be found at a store, in a newspaper, online, on television, in an advertisement, etc.

However, the offers that an individual may use are few in comparison to the amount of offers that are potentially available for a product, brand of product, or type of product. For example, an individual may receive a coupon in a newspaper, cut out the coupon and use it to purchase a product. However, there may be other promotional offers that the individual may not be aware of, such as a promotional offer on the Internet that may be a better deal for the individual. In this way, the individual may miss a promotional offer, because he/she was unable to find the offer.

Therefore, a need exists for individuals to be able to find and receive with ease, one or more available offers for products, brands of products, or types of products that the individual is interested in purchasing.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product and/or other devices) and methods for providing available promotional offers to a user based on product or product category recognition. Thus, providing the user with promotional offers for products or categories of products that the user may actually be interested in purchasing. The products or category of products may be identified by the user and the identification of the product may be sent to a system, such that the system may find one or more available promotional offers for the product identified by the user, products similar to the one identified by the user, and/or products in the same category as the product identified by the user. In this way, the user may receive available promotions for the products the user identifies. Therefore, the invention provides a user with promotional offers for products that the user identifies, thus eliminating the requirement for the user to search for several offers for a product prior to purchasing the product.

In some embodiments, a user may opt-in to using the offer matching program. Opting into the program requires the user to provide identification of a product for which the user wishes to receive offers. The user may provide product identification in several ways, including but not limited to object identification or universal product code (UPC) identification.

In some embodiments, the user may be able to opt-in to using the offer matching program via object identification. Object identification allows a user to take a digital image of an object, real-time video of an object, or provide a keyword associated with a product. The image or video may be taken by a camera, mobile device, etc. and provided to the system. The system may then recognize the object in the image or video as a particular product. This product recognition may occur by recognizing a product by product characteristics, such as, but not limited to the packaging of the product, such as the shape, the color, the wording, a logo etc. on the package; the location of the products; geographical location of the user; scanning a UPC code; and/or the like. For example, a user may take a picture of the contents of his/her refrigerator. The user may send the picture of the contents of his/her refrigerator to the system as a digital image. The system may then match the picture of the contents of the user's refrigerator with particular products by identifying the characteristics of the products. In this example, the system may identify that the user has milk, eggs, and orange juice by the characteristics of the products. Furthermore, the system may recognize the brand of milk, eggs, or orange juice based on the packaging of the products. In some embodiments, a user may provide the system with keyword(s) associated with the product he/she wishes to receive an offer for. The keyword associated with a product allows a user to input a keyword, such as “rice” and the system may provide the user with current available promotional offers for “rice.” In some embodiments, the system may then provide the user with promotional offers for the specific product identified by the user. In other embodiments, the system may provide the user with promotional offers for other products within the same category of goods as the product identified by the user.

In some embodiments, the user may be able to opt-in to the offer matching program via product code identification, such as UPC identification or the like. Code identification allows a user to input or capture the code into a device such as a mobile phone, computer device, or the like. The inputted code may be recognized by the system and matched to a particular product. For example, the user may scan a bar code using a bar scanner application, electronically communicate the code or parts of the code located on the product, to the system. The system may recognize the code as a specific type of product and the advertiser in which the product was purchased. In this way, the system may be able to provide the user with promotional offers for that specific product, products in the same category of products, or promotional offers for the specific advertiser. For example, the user may open his/her refrigerator, capture the code for the milk in his/her refrigerator and initiate electronic communication of the code to the system. The system may then match the code for the milk in the user's refrigerator to a specific product, brand, and advertiser. The system may then provide an offer to the user. In some embodiments, the system may provide the user with promotional offers for the particular product identified by the user via code identification. In other embodiments, the system may provide the user with promotional offers for other products within the same category of goods as the product identified by the user. In yet other embodiments, the system may provide the user with a promotional offer for the same advertiser that provided the user the product identified via code identification.

In some embodiments, the user may be able to opt-in to the offer matching program via voice recognition. Voice recognition allows a user to speak into a device with a microphone, such as a mobile phone, computer device, or the like. The device may recognize that the user said a specific product or category of products, such as the user saying “cereal.” The system may recognize the voice of the user and recognize specific types of products and advertisers that sell that particular product or category of products.

Once the system recognizes the product provided by the user via either object identification or code identification, the system may determine the currently available promotional offers for the product. In some embodiments, the system may determine the currently available promotional offers for the same category of products. A category of products includes a grouping of similar or like products. For example, a television may be in the category of products of electronic devices, such as computers, speakers, etc. In some embodiments, the system may determine the currently available promotional offers for the same brand of product as identified by the user.

The system may then, prior to providing the offer to the user, apply any rules that have been established for the user or the product identified by the user. Rules provide the system with an indication as to the promotional offers that the user has agreed to receive. The rules may be set based on an individual user, individual product, advertiser, etc. In this way, the promotional offer may be different based on the individual requesting the offer, the product requested, or the advertiser. For example, a rule may be established for a particular product from an advertiser, such that if the user has purchased the product several times before, the advertiser may elect to provide the user with a nominal offer. However, if the user has never purchased the product, the advertiser may elect to set a rule providing that user with a more beneficial offer. In this way, the advertiser may set rules to entice new customers, reward customers for loyalty, etc.

In some embodiments, rules may be set based on the user's prior purchases. The user's prior purchases may be determined by the advertiser or by the financial institution providing the offer matching program. An advertiser or financial institution may have an indication as to the user's spending history, including products acquired; amount spent on products; advertisers at which products were acquired; amount spent at specific advertiser; how recently products were acquired; how recently an advertiser was used to make a purchase/transaction; spending/transaction patterns, such as time of date/week/month/year for making purchases/transactions; offers used to make purchases/transactions; social network data; and the like. The user's prior purchase data may be determined based on credit, debit, and other demand deposit account purchases/transactions. In this regard, many of the embodiments herein disclosed leverage financial institution data.

In some embodiments, rules may be set by the financial institution providing the offer matching program. In other embodiments, the advertiser providing the product may set the rules.

Once the system has applied the established rules for the advertiser, product, or user, the user is provided available promotional offers. A promotional offer may be provided to the user in the form of a discount, rebate, coupon, current sale on a product, etc. that may expire within a predetermined amount of time or may be available to the user at any time he/she wishes to make a transaction. In some embodiments, the promotional offers may be for products that match to the product the user identified. In some embodiments, the promotional offers may be products in the same category of products as the product the user identified. In other embodiments, the promotional offers may be for the same brand of product as the product the user identified.

In some embodiments, the offers may be sent to the user via a network to a user device. In other embodiments, the offer may be sent to the user via text massage, voice message, standard mail, a mobile application, to an email address, to a social network site of the user, applied to the user's credit card, applied to the user's reward card, and/or the like.

Embodiments of the invention relate to systems, methods, and computer program products for matching offers to a product. In this regard, embodiments include receiving an indication from a user that the user requests a promotional offer for a product; determining, based on the indication from the user, an identification of the product the user is requesting the offer for, wherein the product is identified based at least in part on a matching of characteristics of the product with characteristics of a known product in a database; matching the identified product with offers available for that product; filtering the offers based on pre-established rules; and directing the offers to the user based at least in part on a received indication from the user. Furthermore, the invention further comprising processing the indication from the user to determine the product associated with the indication.

In some embodiments, processing the indication from the user to determine the product associated with the indication further comprises determining product characteristics associated with the product associated with the indication, such that a product may be identified by the product characteristics. Product characteristics further comprise packaging of the product. Product characteristics further comprise logos associated with the product.

In some embodiments, pre-established rules provide indications as to which user may receive the promotional offer based on the user's transaction history with an entity providing the product.

In some embodiments, the indication from the user that the user requests an offer for a product may be a scanned bar code. The indication from the user that the user requests an offer for a product may also include a keyword associated with the product. The indication from the user that the user requests an offer for a product may also be a product number associated with the product. The indication from the user that the user requests an offer for a product may also be an image of the product.

In some embodiments, the offer for the product is a coupon for the product. The offer for the product may also be directed to the user through a user application.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating an offer matching program process, in accordance with one embodiment of the present invention;

FIG. 2 provides an offer matching program system environment, in accordance with one embodiment of the present invention;

FIG. 3 provides a process map illustrating the determination of offers, in accordance with one embodiment of the present invention;

FIG. 4a provides a representation illustrating object identification, in accordance with an embodiment of the invention;

FIG. 4b provides a representation illustrating a UPC display environment for UPC identification, in accordance with one embodiment of the present invention

FIG. 5 provides a process map illustrating a user's selection process, in accordance with one embodiment of the present invention;

FIG. 6 provides a product interface, in accordance with one embodiment of the present invention; and

FIG. 7 provides an offer interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by an advertiser. In addition, the term “offer” or “promotional offer” is used herein to denote any form of offer, promotion, rebate, coupon, incentive, sale event, and/or the like offered for the purchase, lease, and/or the like of a product. A “advertiser” as used herein may refer to a manufacturer, retailer, merchant, service provider, event provider, warehouse, supplier, commercial partner of a financial institution, and/or the like.

Although some embodiments of the invention herein are generally described as involving a “financial institution,” one of ordinary skill in the art will appreciate that other embodiments of the invention may involve other businesses that take the place of or work in conjunction with the financial institution to perform all of the processes or steps described herein as being performed by a financial institution. Still in other embodiments of the invention the financial institution described herein may be replaced with other types of businesses that offer payment account systems to users.

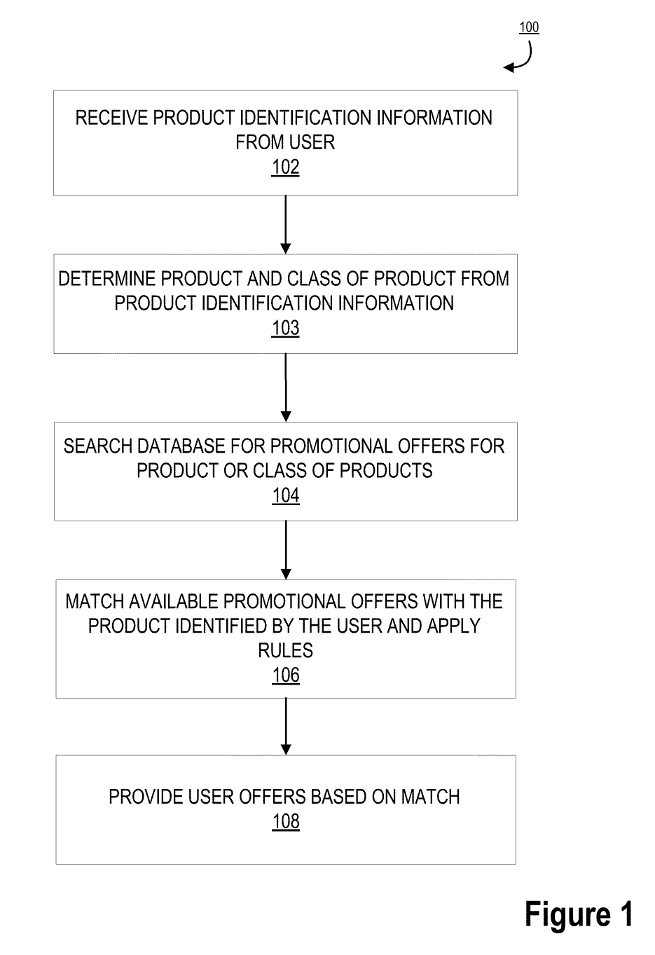

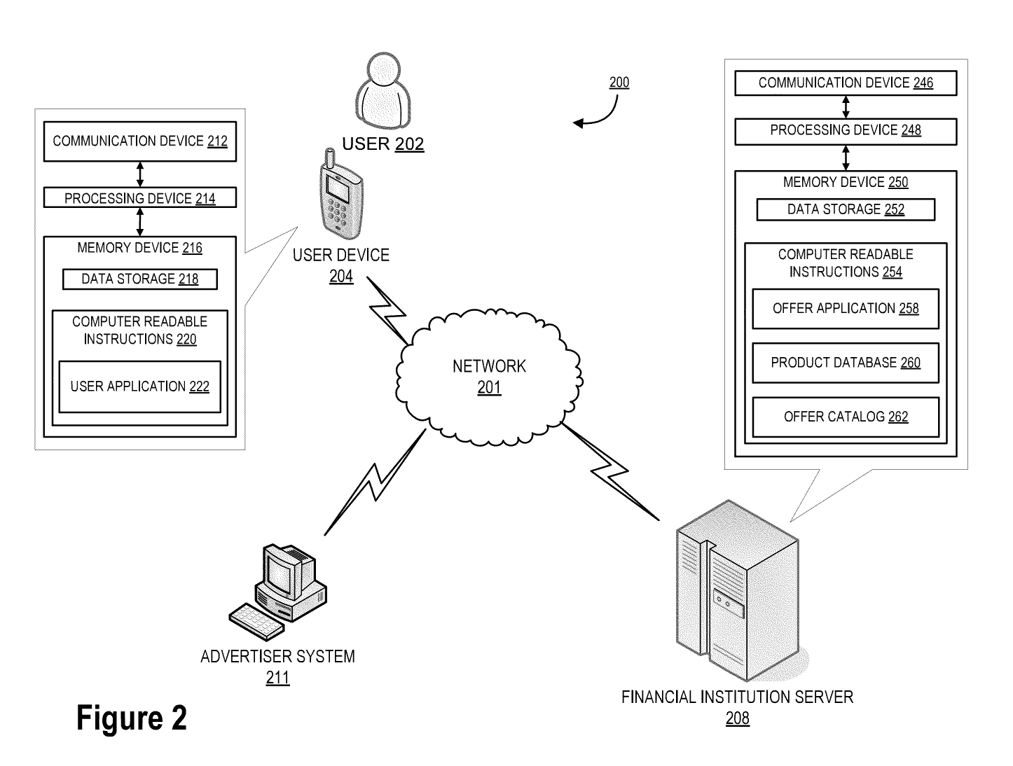

FIG. 1 illustrates a high level process flow for an offer matching program process 100, which will be discussed in further detail throughout this specification with respect to FIGS. 2 through 7. The first step in the process 100 is to receive product identification information from a user, as illustrated in block 102. This product identification information also serves as an opt-in to the offer matching program for the user. The user may provide product identification by either object identification, code identification, such as UPC, Quick Response (QR) or the like or any other product identification mechanism. In this way, the user may provide the system with information in various ways that are convenient to a user, whether the user is utilizing a mobile device, computer device, telephone, tablet device, and/or the like. The next step in the process 100 is to determine the product or category of products from the product identification information provided by the user, as illustrated in block 103. In one embodiment, the product is determined based on an object identification. The object identification may be a picture, video, or keyword inputted by the user and provided to the system, such that from the picture, video, or keyword the system may be able to determine the specific product. In other embodiments, the product is determined based on the code identification information provide by the user by either direct input or scanning the code. In those embodiments in which the code is a UPC code, the UPC identification may be some or all of an inputted twelve-digit UPC code associated with a product. In this way, the system may determine the specific product and advertiser that is selling the product based on the user's input of the UPC code associated with that product.

Next, in block 104, the system searches a database to find one or more promotional offers for the product identified in block 103. In some embodiments, the available promotional offers may include offers for the product identified by the user, products in the same category as the product identified by the user, the same brand of products as the product identified by the user, products sold by the same advertiser, or products that are associated with the products of the advertiser that match the product identified by the user. Once the promotional offers for a product, category of product, advertiser, brand, etc. are found, a match is made between one or more of the promotional offers found on the directory and the product identified by the user, as illustrated in block 106. The match comprises determining the promotional offers available to the user, based on the application of rules for the promotional offers. In this way, only the offers available for that particular user may be provided to the user. For example, some promotional offers may only be available to specific users, therefore that particular promotional offer may not be provided to other users. In other embodiments, the rules may provide a sliding promotional offer scale. For example, depending on specific advertiser factors, an offer may be good for the range of 10 to 50 percent off. Therefore, one user may receive 10 percent off for a product, but another user may receive 50 percent off for the same product, based on the advertiser factors. In this way, one or more promotional offers for a particular product may not be provided to a user, but instead one or more offers available to the user will be provided to the user. The advertiser, financial institution, system, or the like may include any rules that may limit or expand the promotional offer provided to an individual user or all users. The promotional offers available to the user are then provided to the user based on the match in block 106, as illustrated in block 108.

FIG. 2 provides an offer matching program system environment 200, in accordance with one embodiment of the present invention. As illustrated in FIG. 2, the financial institution server 208 is operatively coupled, via a network 201 to the user device 204 and to an advertiser system 211. In this way, the financial institution server 208 can send information to and receive information from the user device 204 and the advertiser systems 211, to identify products, match products to promotional offers, and provide offers to a user 202 in the offer matching program. FIG. 2 illustrates only one example of an embodiment of an offer matching program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The individual may be an account holder at the financial institution or not associated with the financial institution. The individual may wish to purchase products using any offer that is available for those products.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are located between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the user device 204 and the advertiser system 211. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of an offer application 258. In another embodiment the computer-readable instructions 254 stored in the memory device 250 includes the computer-readable instructions 254 of a product database 260. In another embodiment the computer-readable instructions 254 stored in the memory device 250 includes the computer-readable instructions 254 of an offer catalog 262. In some embodiments, the memory device 250 includes data storage 252 for storing data related to the financial institution including but not limited to data created and/or used by the offer application 258, the product database 260, or the offer catalog 262.

In the embodiment illustrated in FIG. 2 and described throughout much of this specification, the offer application 258 allows the user 202 to interact with the system. First, the offer application 258 allows a user 202 to opt-in to the offer matching program, via the user's 202 user device 204. In some embodiments, the user 202 may opt-in by the Internet, visiting a financial institution, text messaging, voice messaging, accessing an interface, online banking, via applications, or the like. In some embodiments, the offer application 258 allows the user 202 to communicate, via the user device 204, to indicate a desire to opt-in to the optimized offer program. In other embodiments, the user 202 may automatically opt-in to the offer matching program when the user 202 provides product identification information to the system 200.

In some embodiments, the offer application 258 may provide the user 202 with a platform to provide product identification information. In other embodiments, the offer application 258 may receive product identification information from the user 202. The product identification information received by the offer application 258 may be in the form of object identification, code identification, voice recognition, or the like. In some embodiments, the offer application 258 may determine a product the user 202 wishes to receive offers for based on object identification information provided by the user 202. Object identification information allows a user 202 to take a digital image of a product, real-time video of a product, or provide keywords associated with a product that the user 202 wishes to receive a promotional offer for, such that the offer application 258 may determine the product the user 202 is wishing to receive offers for. This product recognition may occur by the offer application 258 recognizing a product by the product's characteristics, such as, but not limited to the packaging of the product, such as the shape, the color, the wording, the logo etc. on the package; the location of the products; geographical location of the user; scanning a code; and/or the like.

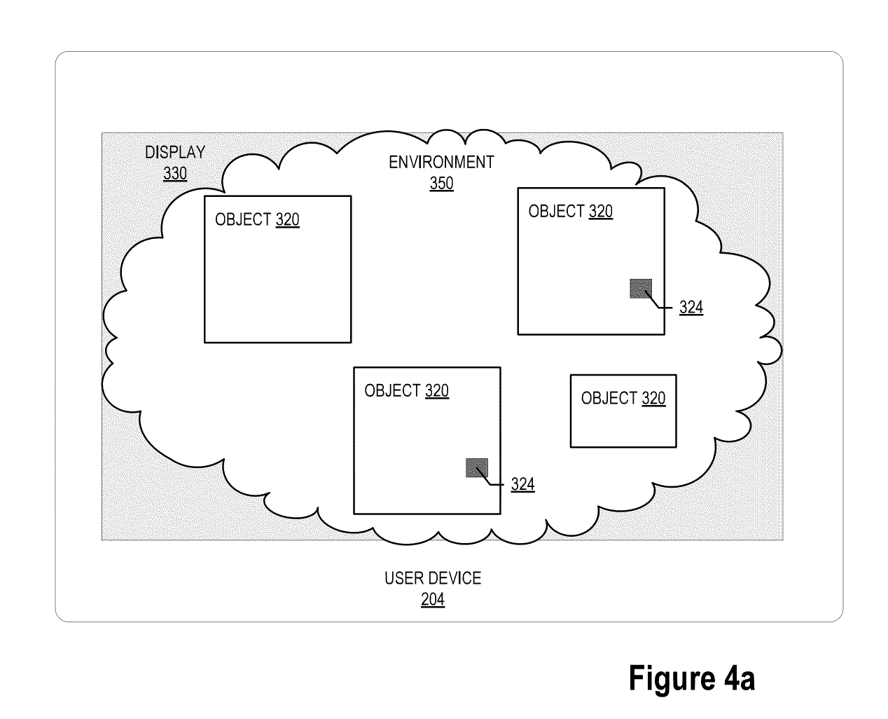

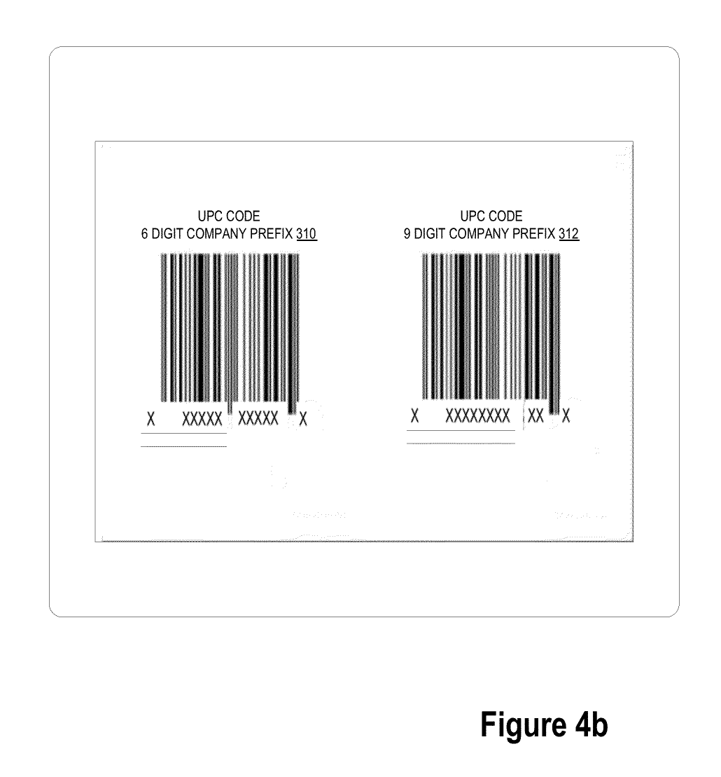

In some embodiment, as discussed in further detail below with respect to FIG. 4a, the user 202 may provide a digital image of the product the user 202 may wish to receive offers for to the offer application 258 for object identification purposes. In this way, the offer application 258 may analyze the digital image of the product to determine the product characteristics of the product the user 202 wishes to receive offers for. For example, the offer application 258 may be able to determine the location of the product in the picture (e.g., in a retail store, the user's home, etc.), shape of the product (e.g., round, in a box, size of packaging, size of product, etc.), color of product, font of lettering on product, code on product, etc. Once the product characteristics are established by the offer application 258 the offer application 258 may then search the product database 260 from products with the same or similar characteristics as those products in the digital image the user 202 took.

In some embodiments, as discussed in further detail below with respect to FIG. 4a, the user 202 may provide a real-time video stream of an object to the offer application 258 for object identification purposes. A real-time video stream may include images of products, advertisers, or the like. For example, a user 202 may move about an aisle within a retail advertiser while capturing a real-time video stream of the environment including the products on the shelves in the aisle. In another embodiment of the invention, a user 202 may move about a city street or shopping mall while capturing a real-time video stream of the environment including the advertisers located on the street or within the mall. In this way, the offer application 258 may analyze the real-time video stream to determine if products or advertisers are within the stream. Similar to above with respect to a digital image, the offer application 258 may determine product characteristics of the product within the real-time video stream that the user 202 may wish to receive offers for. Once the product characteristics are established by the offer application 258 the offer application 258 may then search the product database 260 from products with the same or similar characteristics as those products in the real-time video of the user 202.

In yet other embodiments, the user 202 may provide keywords associated with a product to the offer application 258 for object identification purposes. This allows a user 202 to input keyword(s) associated with a product that the user 202 wishes to receive promotional offers for. The user 202 may input the keyword(s) using any means that may allow the user 202 to transmit keyword(s) to the offer application 258, this may include, but is not limited to user devices 204, mobile devices, computer devices, cellular phones, (personal digital assistants) PDAs, tablet computer devices, etc.

In some embodiments, the user 202 may provide voice recognition associated with the product to the offer application 258 for product identification purposes. This allows a user 202 to provide a voice command or to speak words associated with the product or category of products into a user device 204, mobile device, computer device, cellular phone, (personal digital assistant) PDA, tablet computer device, and/or other devices with a microphone, for which a user 202 wishes to receive promotional offers. For example, a user 202 may speak the word “cereal” into the microphone of his/her user device 204, they system may recognize the word “cereal” and provide the user 202 offers for products and products in the same category as the word the user 202 spoke.

In some embodiments, the offer application 258 may determine a product the user 202 is wishing to receive offers for based on code identification information provided by the user 202. As discussed in further detail below with respect to FIG. 4b, code identification allows a user 202 to capture the code with a user device 204, such as a mobile phone, handheld computer device, or the like. In specific embodiments, the inputted code may include one or more or some of the numbers associated with the code. In some embodiments, a UPC code may include a 12 digit code and include either a 6 or 9 digit company prefix. The user 202 may provide part of or all of the code associated with the product the user 202 wishes to receive offers for. The offer application 258 may then match the user 202 inputted code with the codes in the product database 260. The product database 260, as discussed in further detail below may store codes that correlate not only to the specific product that the user 202 wishes to receive offers for, but may also determine the advertiser from which that product was purchased. For example, the user 202 may be at his/her friend's house and be impressed with the friend's television. Therefore, the user 202 may be able to input a portion of or all of the product code associated with his/her friend's television. Thereafter, the offer application 258 may provide the user 202 with offers for that particular brand of television and also indicate what advertiser the television was purchased from.

The product database 260 stores information regarding products that the user 202 may wish to receive offers for. The product database 260 includes information, such as product characteristics and/or code information for each product that has an offer associated with it. The product database 260 also stores categorical information relating to potential products that are associated with the product provided by the user 202. In this way, the product database 260 has information relating to products in the same category as the product the user 202 identified. For example, if the user 202 has identified cereal as the product he/she is interested in receiving offers for, the product database 260 may identify the cereal as being in the category of breakfast foods. Therefore, the system may determine and provide the user 202 with offers for other breakfast foods, such as eggs, granola bars, etc. Furthermore, the product database 260 may continue to store information regarding newly developed products or products not currently on the product database 260. The product database 260 may actively search for these products using the Internet or the like to continually find products. In some embodiments, the product database 260 stores product characteristics, such as, but not limited to product packaging, shape, design, wordage, code scanner data, etc. In this way, the product database 260 may store the products with an indication as to the product characteristics, such that the offer application 258 may search the product database 260 using product characteristics or keywords to find a particular product within the product database 260. In some embodiments, the product database 260 stores code numbering, such as UPC numbering, for products, such that the offer application 258 may search the products on the product database 260 based on the code.

The product that the user 202 wishes to receive offers for may be identified by the offer application 258. Prior to searching the offer catalog 262 to determine the offers available for the identified product or category of products, the offer application 258 may store the information relating to the product, category of product, brand, or advertiser associated with the product. In this way, the system may compile the data regarding the products that users 202 are most likely looking for offers for and provide that information to advertisers.

Once the product that the user 202 wishes to receive offers for has been identified by the offer application 258, the offer application 258 may search the offer catalog 262 to determine the offers available for the identified product. In other embodiments, the offer application 258 may find promotional offers within the offer catalog 262 for other products within the same category of products as the product identified by the user 202. In yet other embodiments, the offer application 258 may find promotional offers within the offer catalog 262 for products from the same advertiser as the product identified by the user 202.

The offer catalog 262 includes one or more available offers for products in the product database 260. The promotional offers in the offer catalog 262 include offers provided to the catalog by various advertiser systems 211. Furthermore, the offer catalog 262 through the use of a network 201 may search the Internet for up-to-date offers, sales, etc. that may be available for products on the product database 260. In this way, the offer catalog 262 may comprise up-to-date offers for one or more products, such that a user 202 may receive the most recent promotional offers available.

Prior to providing the available offers to the user 202, the offer application 258 may review and apply any rules that may have been established for that user 202, advertiser, or product. Rules provide the offer application 258 with an indication as to the promotional offer that the user 202 may receive. For example, the promotional offer provided to the user 202 may be different based on the individual user 202 requesting the offer, the product requested, or the advertiser. A rule may be established for a particular product from an advertiser, such as a merchant. In this way, the advertiser may be able to regulate which users 202 receive more beneficial promotional offers compared to other users 202. Therefore, the advertiser may set rules to entice new customers, reward customers for loyalty, etc.

In some embodiments, rules may be set based on the user's 202 prior purchases. The user's 202 prior purchases may be determined by the financial institution server 208 or the advertiser system 211. Prior purchases may provide an indication as to the user's 202 spending history, including products acquired; amount spent on products; advertisers at which products were acquired; amount spent at specific advertiser; how recently products were acquired; how recently a particular merchant was used to make a purchase/transaction; spending/transaction patterns, such as time of date/week/month/year for making purchases/transactions; offers used to make purchases/transactions; social network data; and the like. The user's 202 prior purchase data may be used to also create rules that are individualized to a particular user 202. In some embodiments, rules may be set by the financial institution providing the offer matching program. In other embodiments, the advertiser providing the product may set the rules.

Once the system has applied the established rules for the advertiser, product, or user 202, the offer application 258 may provide the user 202 one or more available promotional offers. An available promotional offer may be provided to the user 202 in the form of a discount, rebate, coupon, current sale on a product, etc. that may expire within a predetermined amount of time or may be available to the user 202 at any time he/she wishes to make a transaction. In some embodiments, the promotional offers may be for products that the match to the product the user 202 identified. In some embodiments, the promotional offers may be for products in the same category of products as the product the user 202 identified. In other embodiments, the promotional offers may be for the same brand of product as the product the user 202 identified.

In some embodiments, the offers may be sent to the user 202 from the offer application 258 via a network 201, to the user device 204. In other embodiments, the offer may be sent to the user 202 by any other communication mechanism, such as via text massage, voice message, standard mail, a mobile application, to an email address, to a social network site of the user 202, applied to the user's 202 credit card, applied to the user's 202 reward card, and/or the like.

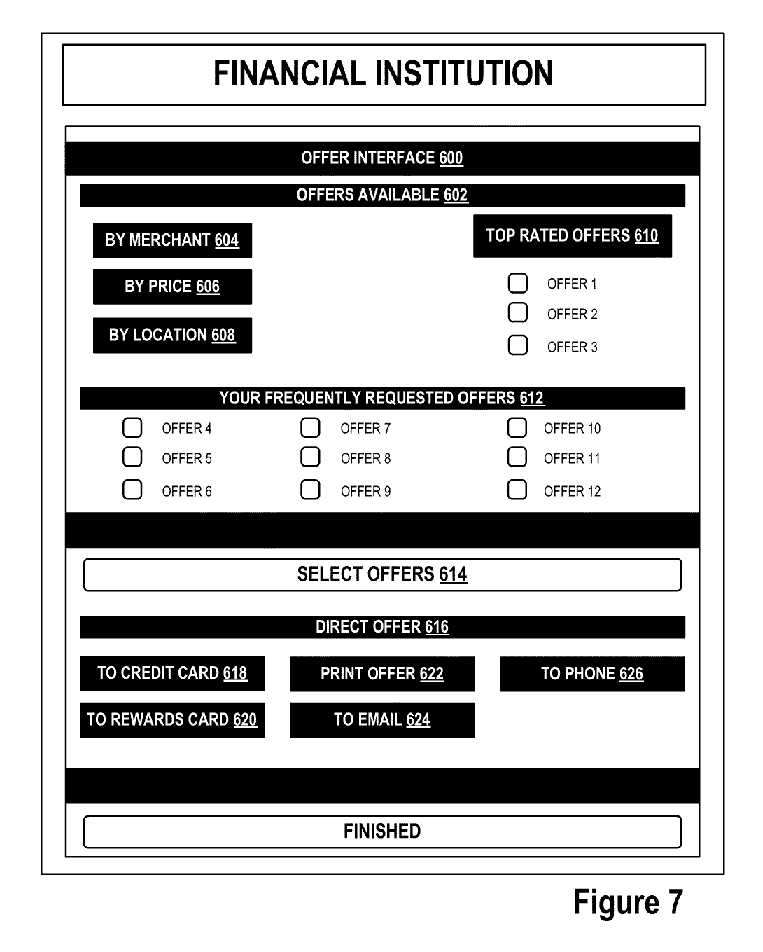

Furthermore, the offer application 258 may comprise an artificial intelligence (AI) or other type of intelligence program provided. In this way, the offer application 258 may analyze the user's 202 offer request history to learn what types of products that specific user 202 typically wishes to receive offers for. In this way, the offer application 258, may provide the user 202 with promotional offers prior to the user 202 identifying a product he/she wishes to receive an offer for. In this way, the offer application 258 may be able to make intelligent, yet predicted offer recommendations for the user 202. These offers may be provided to the user 202 in many ways, including but not limited to email, mail, text message, voice message, applications, interfaces, such as the one illustrated in FIG. 7, and/or the like.

FIG. 2 also illustrates a user device 204. The user device 204 generally includes a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 208 and the advertiser systems 211. As such, the communication device 212 generally includes a modem, server, or other device for communicating with other devices on the network 201.

As further illustrated in FIG. 2, the user device 204 include a computer-readable instructions 220 stored in the memory device 216, which in one embodiment includes the computer-readable instructions 220 of a user application 222. In this way, a user 202 may be able to opt-in to the offer matching program, provide object identification, code identification, receive offers, deny offers, accept offers, and/or the like using the user application 222. In some embodiments, the memory device 216 includes data storage 218 for storing data related to the user device 204 including but not limited to data created and/or used by the user application 222. A “user device” 204 may be any communication device, such as a cellular telecommunications device (e.g., a cell phone or mobile phone), personal digital assistant (PDA), a mobile Internet accessing device, Internet accessing device, or other device including, but not limited to PDAs, pagers, televisions, gaming devices, laptop computers, desktop computer, cameras, video recorders, audio/video player, radio, Global Positioning System (GPS) devices, any combination of the aforementioned, or the like. Although only a single user device 204 is depicted in FIG. 2, the payment account determination system environment 200 may include numerous mobile devices 204.

The advertiser systems 211 are operatively coupled to the financial institution server 208 and the user device 204 through the network 201. The advertiser systems 211 have systems with devices the same or similar to the devices described for the financial institution server 208 and/or the user device 204 (e.g., communication device, processing device, and memory device). Therefore, the advertiser systems 211 communicates with the financial institution server 208 and/or the user device 204 in the same or similar way as previously described with respect to each system.

The advertiser systems 211, in some embodiments, provide the offer application 258 data with respect to the offers available from the advertiser. This data may include one or more offers that advertisers may wish to provide to users 202 of the offer matching program. The data may include the offer, the product the offer is directed, rules regarding the offers, and the like. The rules on the offer may be a percentage discount not to exceed, a location limitation, a number of offers provided limitation, a number of products purchased using the offer limitation, a limited number of users 202 that may qualify for the offer, etc.

In some embodiments, the advertiser systems 211 may provide offer acceptance history of a user 202 to the offer application 258. The advertiser may have data regarding the purchases of users 202 when the users 202 purchased products from an advertiser or merchant, such as which purchases the user 202 made with an offer. The offer the user 202 has previously used at the advertiser may or may not be an offer provided to the user 202 via the offer matching program. In this way, the advertiser systems 211 may provide the offer application 258 user 202 offer acceptance history for that advertiser, such that the offer application 258 may further learn the types of products a user 202 typically uses an offer for.

It is understood that the servers, systems, and devices described herein illustrate one embodiment of the invention. It is further understood that one or more of the servers, systems, and devices can be combined in other embodiments and still function in the same or similar way as the embodiments described herein.

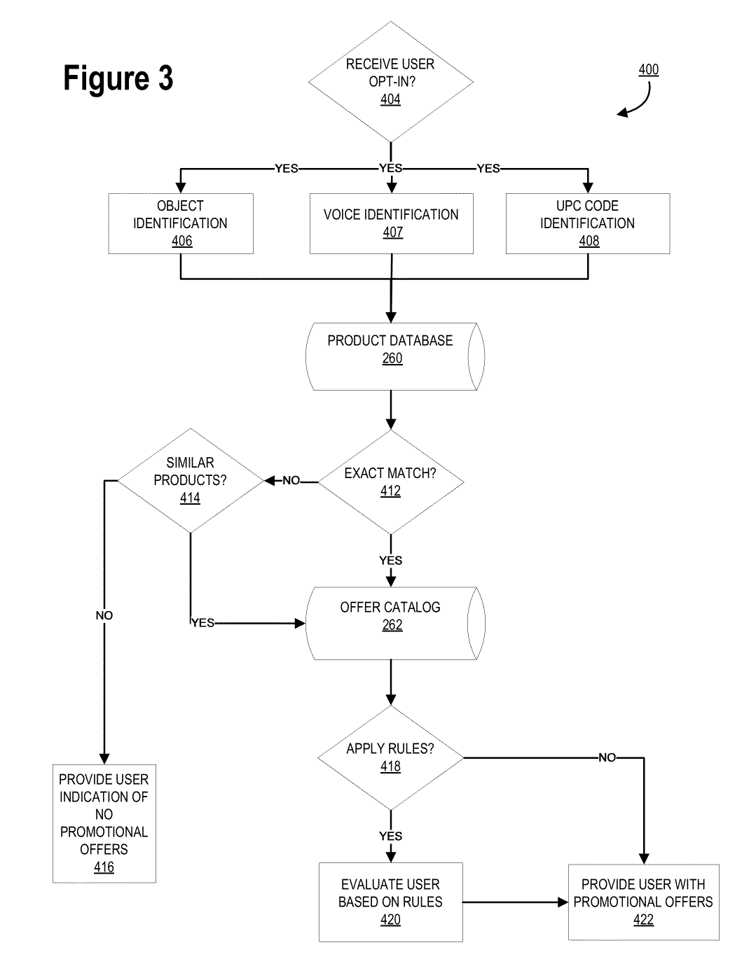

FIG. 3 illustrates a flow chart of the process of determining offers for the offer matching program 400, in accordance with one embodiment of the present invention. The flow chart illustrates the flow of data throughout the system. As illustrated in block 404, the system may receive an indication from the user 202 that he/she wishes to opt-in to receive promotional offers via the offer matching program. In some embodiments, the user 202 may opt-in, such that the user 202 may indicate that he/she wants to receive promotional offers via the offer matching program. The user 202 may opt-in via the Internet, visiting a financial institution, text messaging, voice messaging, accessing an interface, a mobile application, or the like. In some embodiments, the user 202 may opt-in to the offer matching program by identifying a product that the user 202 is interested in receiving promotional offers for. The user 202 may provide the products he/she wishes to receive offers for by either providing object identification 406, voice identification 407, or a code, such as an UPC code identification 408 or the like.

Object identification 406 is further illustrated in FIG. 4a. FIG. 4a further illustrates a user device 204 wherein the user 202 has executed either a digital image or real-time video capture displaying products, in the form of objects 320 in a surrounding environment 350 on the display 330 of the user device 204. In some embodiments, the user device 204 is configured to scan codes, such as UPC codes 324 to identify objects 320, such as products. As illustrated in FIG. 4a, if an object 320 does not have any codes 230 that are visualized within the real-time video display or digital image, the object 320 will be displayed to the system to determine if the object is a product. If the object 320 is a product, the system may then determine the product characteristics. Product characteristics are any characteristics that may aid the system in determining exactly what product is in the image provided by the user 202. Product characteristics include, but are not limited to the location of the product in the picture (e.g., in a retail store, the user's 202 home, etc.), shape of the product (e.g., round, in a box, size of packaging, size of product, etc.), color of product, font of lettering on product, code, such as UPC code 324 on product, etc.

The system may use any type of means in order to identify the objects 320 as a product. For instance, the system may utilize one or more pattern recognition algorithms to analyze objects in the environment 250 and compare with scanned codes 230 in the product database 260 which may be included within the system. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 320 as a product within the real-time video stream or image, the system is configured to send the identified image to the product database 260 to determine if a match exists between the product in the real-time video stream or image and a product stored in the product database 260.

Object identification 406 may also comprise keyword identification, which allows a user 202 to input a keyword or keywords such that the system may search the product database 260 for products that match the keyword or keywords.

Voice identification 407 allows a user 202 to provide voice information to the system, such that the system may identify products or categories of products that a user 202 wishes to receive an offer for, based on the voice information provided by the user 202. For example, the user 202 may wish to receive an offer for a vacuum cleaner. The user 202 may say “vacuum cleaner” into a microphone on a user device 204 or the like. The system may identify that the user 202 is requesting an offer for a vacuum cleaner and provide the user 202 with offers for vacuum cleaners as well as products in the same category of products as vacuum cleaners, such as other cleaning supplies.

The user 202 may also provide code identification 408. Code identification 408 is further illustrated in FIG. 4b. FIG. 4b further illustrates various UPC codes that may be located on a product. Code identification allows 408 a user 202 to input the code into a device such as a user device 204, mobile phone, computer device, or the like. In one example, in which the code is UPC code, the inputted UPC code may include one or more or some of the numbers associated with the UPC code. In some embodiments, the UPC code may comprise a 12 digit code and include between a 6 to 10 digit company prefix.

Section 310 provides a 6 digit company prefix, as shown with a double underline under the 6 digits that include the company prefix. In this example, the user 202 may input the complete UPC code and the system will determine using the product database 260 which advertiser the product comes from as well as the product. For example, if the UPC code including the 6 digit company prefix 310 is provided to the system, the system will recognized the company prefix assigned by the GS1 US (formerly the Uniform Code Council) and be able to determine the advertiser from the UPC code. From there, the system may determine, from the remaining numbers, the advertiser's internal Stock Keeping Unit (SKU). The SKU is associated with an individual product within the advertiser. The system may receive this information from an advertiser system 211 or have it pre-established within the product database 260.

As illustrated in Section 312 a UPC code with a 9-digit company prefix. The 9-digit company prefix is illustrated with a double underline. The system may recognize this UPC code as a 9-digit company prefix code and determine the advertiser that is associated with that company prefix. From that point, the system may determine from the remaining digits the product associated with the UPC code based on the SKU from the advertiser or pre-established in the product database 206. In some embodiments, the user 202 may provide part of the UPC code associated with the product the user 202 wishes to receive offers for. In other embodiments, the user 202 may provide one or more of the UPC codes associated with the product the user 202 wishes to receive offers for.

Upon identifying a product based on code identification, the system is configured to send the identified code to the product database 260 to determine if a match exists between the product of the corresponding code and a product stored in the product database 260.

Referring again back to FIG. 3, the product identified either by the object identification 406 or the code identification 408 may be matched with a product in the product database 260. The product database 260 stores information regarding products that the user 202 may wish to receive offers for. The product database 260 comprises information, such as product characteristics and/or code information for each product that has an offer associated with it. Furthermore, the product database 260 may continue to store information regarding newly developed products or products not currently on the product database 260. The product database 260 may actively search for these products using the Internet or the like to continually find products. In some embodiments, the product database 260 stores product characteristics, such as, but not limited to product packaging, shape, design, wordage, code scanner data, etc. In this way, the product database 260 may store the products with an indication as to the product characteristics, such that the offer application 258 may search the product database 260 using product characteristics or keywords to find a particular product within the product database 260. In some embodiments, the product database 260 stores code numbering for products, such that the offer application 258 may search the products on the product database 260 based on the code.

In decision block 412 the system determines if there is an exact match between the user 202 identified product and a product on the product database 260. If no exact match between the product identified by the user 202 and the products on the product database 260, the system determines in decision block 414 is there are similar products to the product identified by the user 202. Similar products may include products that are of the same category, brand, type, or the like. If no exact match or similar product exists in the product database 260, then the system may provide the user with an indication of no promotional offer in block 416.

If it is determined that either an exact match, in decision block 412 or similar products, in decision block 414 exists, then the products are matched to offers located within the offer catalog 262. Promotional offers found in the offer catalog 262 may include offers for the exact product the user 202 wishes to receive offers for, similar products to the one the user 202 wishes to receive offers for, products from the same advertiser as the product identified by the user 202, etc. The offer catalog 262 comprises one or more available offers for products in the product database 260. The promotional offers in the offer catalog 262 include offers provided to the catalog by various advertiser systems 211. Furthermore, the offer catalog 262 through the use of a network 201 may search the Internet for up-to-date offers, sales, etc. that may be available for products on the product database 260. In this way, the offer catalog 262 may comprise up-to-date offers for one or more products, such that a user 202 may receive the most recent promotional offers available.

Once the system matches the products identified by the user 202 with one or more offers from the offer catalog 262, the system may determine in decision block 418 whether rules apply to the offers prior to providing the offers to the user 202. If rules do not apply to the promotional offers that are available, then the user is provided promotional offers in block 422.

However, if rules apply to the promotional offer based on an establishment of the rules from the advertiser or financial institution, the user 202 and product must be evaluated based on the rules as illustrated in block 420. In some embodiments, a rule may be established for a particular product. In some embodiments, a rule may be established for a particular user 202. In this way, the advertiser may be able to regulate which users 202 receive more beneficial promotional offers compared to other users 202. Therefore, the advertiser may set rules to entice new customers, reward customers for loyalty, etc.

In some embodiments, rules may be established based on the product. Rules established for a particular product may be applied to every user 202 wishing to receive offers for that particular product or a portion of the users. These rules include limiting the number of offers for the product, limiting the discounts associated with the offers for the product, providing offers for other products instead of the identified product, or the like.

In some embodiments, rules may be established base on the user 202. Rules based on the user 202 may be based on the user's 202 prior purchases. The user's 202 prior purchases may be determined by the system. Prior purchases may provide an indication as to the user's 202 spending history, including products acquired; amount spent on products; advertisers at which products were acquired; amount spent at specific advertiser; how recently products were acquired; how recently a particular merchant was used to make a purchase/transaction; spending/transaction patterns, such as time of date/week/month/year for making purchases/transactions; offers used to make purchases/transactions; social network data; and the like. The user's 202 prior purchase data may be used to also create rules that are individualized to a particular user 202.

Once the system has evaluated the user 202 and product based on the rules in block 420, the user 202 may be provided one or more available promotional offers available for the product identified by the user 202, as illustrated in block 422. An available promotional offer may be provided to the user 202 in the form of a discount, rebate, coupon, current sale on a product, etc. that may expire within a predetermined amount of time or may be available to the user 202 at any time he/she wishes to make a transaction. In some embodiments, the promotional offers may be for products that the match to the product the user 202 identified. In some embodiments, the promotional offers may be for products in the same category of products as the product the user 202 identified. In other embodiments, the promotional offers may be for the same brand of product as the product the user 202 identified.

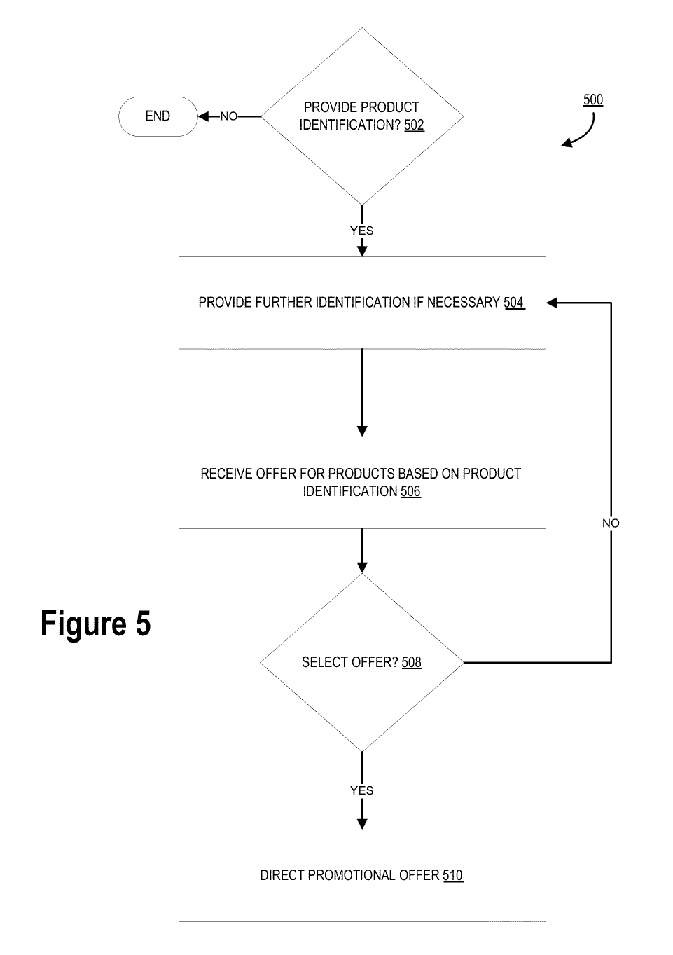

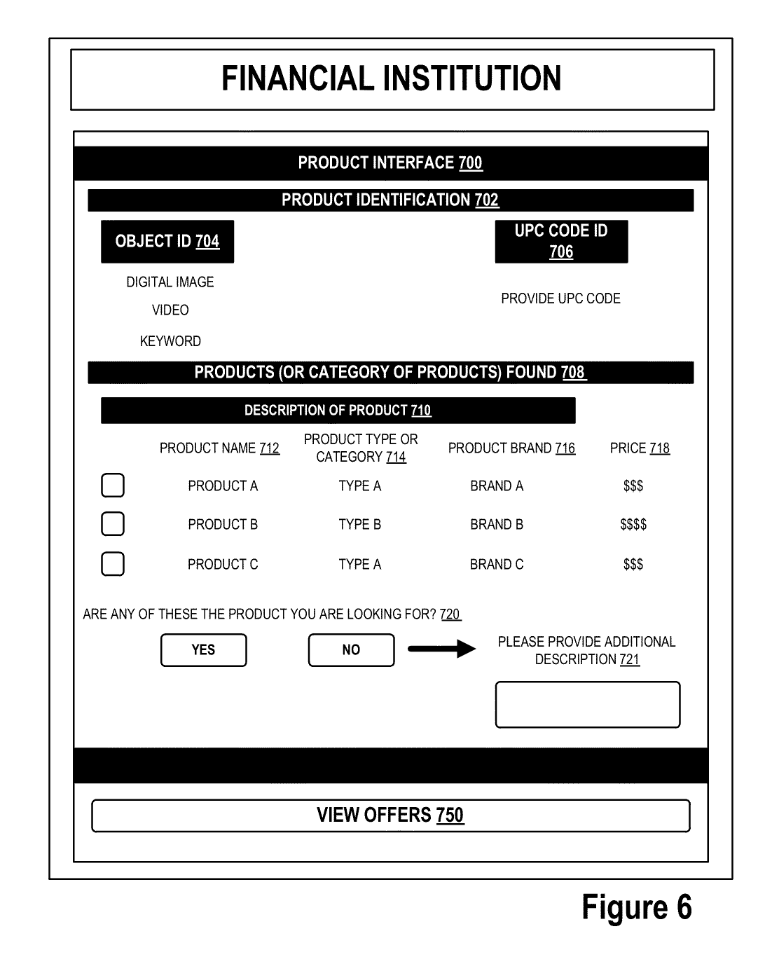

FIG. 5 illustrates a process map of a user's selection process 500. To start the user 202 selection process 500 a user 202 may provide a product identification in decision block 502. If the user 202 does not provide a product identification, the user selection process 500 ends. If a user 202 does provided a product identification, the user 202 may do so in several ways, including an interface, such as that illustrated in FIG. 6.

FIG. 6 illustrates one embodiment of a product interface 700. The product interface 700 may be provided to the user 202 via the user device 204. In the product identification section 702, the user 202 may select either the object identification section 704 or the code identification section 706. The object identification section 704 allows a user 202 to select either to provide a digital image, a video, or a keyword to provide product identification. Once selected, the user 202 may prompted to a camera, video, or text application respectfully. The code identification section 706 allows a user 202 to select the provide code selection to be directed to a text, voice, or other numeric indication means for the user 202 to provide the system with some or one or more of a code associated with the product the user 202 wishes to receive a promotional offer for.

Next, in section 708, the product interface 700 provides the user 202 with the products found by the system. In some embodiments, the system may not provide a list of products found, but instead only provide the product identified by the user 202. However, in some embodiments the system may not be able to match a product identification provided by the user 202 and a product on the product database 260 with certainty. In this way, the system may provide the user 202 with sever different possible product matches in the products found section 708 of the product interface 700. The products found are the products that are found on the product database 260 that are similar to the identified products the user 202 wishes to receive an offer for. In the products found section 708, the system may provide the user 202 with a description of the products found in section 710. The description includes the product name 712, the product type or category 714, the product brand 716, the original price of the product 718, and in some embodiments a thumbnail picture of the product. In this way, the user 202 may examine the descriptions of the products identified in the product database 260 as matching or being in the same category of products as the product in which the user 202 identified and wishes to receive an offer for. If one of the products listed in the products found section 708 is the same or similar product as the product the user 202 identified, the user 202 may select that product by selecting the check box associated with that particular product. In this example, the product that may have matched the product that the user 202 identified is product B. Product B has a type B and is brand B. The user 202 may select the checkbox corresponding to product B and then select the view offers button 750.

In some embodiments, the system may not provide a products found section 708. In these embodiments, the system may be able to recognize the exact product that the user 202 initially identifies. In this way, there is no need for the system to present a products found section 708 because the system has already matched the user 202 identified product with the products on the product database.

Block 504 of FIG. 5 illustrates that if the products found are not a match with the product originally identified by the user 202 the user 202 may need to provide further identification. The user 202 may do this by using the product interface 700 illustrated in FIG. 6. In the products found section 708, if the user 202 does not find the product he/she originally identified among the products found 708 list provided by the system, the user 202 may select the no button under “are any of theses the products you are looking for” section 720. The user 202 may then be prompted to provide additional description in section 721. The user 202 may input additional description in the field provided via typing, texting, or voice messaging. The additional description may be any type of description of the product characteristics that may aid the system in identifying the proper product the user 202 wishes to receive promotional offers for. In some embodiments, the user 202 may have to provide additional description if the original digital image, video, keyword, or the code was provided inaccurately. In other embodiments, the user 202 may have to provide additional description if the original digital image, video, keyword, or the code provided too many results, such that the field of products may be narrowed prior to providing the user 202 with offers. In yet other embodiments the user 202 may provide additional description if the system is having trouble discerning a product from the original digital image, video, keyword, or the code or if the system cannot find a product in the product database 260.

Referring back to FIG. 5, once the user 202 has provided product identification in decision block 502 and provided, if necessary, additional identification in block 504, the user may receive offers for products base on the products the user 202 originally identified, as illustrated in block 506. The user 202 may receive the offers for products several ways, including, but not limited to via text message, voice message, email, social networking, mobile application, application, etc. In some embodiments, the user 202 may receive offers via an interface, such as the offer interface 600 as illustrated in FIG. 7.

FIG. 7 illustrates one embodiments of an offer interface 600. The offer interface may provide the available offers to the user 202. In section 602 the offers available to the user 202 are displayed. If there are several offers available for the identified product, similar products, or within the same category of products, the offer interface 600 may provide categories for the user 202 to easily search for the offer he/she wishes to use. The categories include searching the available offers by advertiser 604, by price 606, or by location 608. The user 202 may select one or more of the categories to search the offers that are available to the user 202 based on the product the user 202 originally identified. The offers may include offers for the exact product identified, similar products, products in the same category, competitor's products, products by the same advertiser, products of the same brand, etc. Furthermore, the offers available section 602 also provides the user 202 with a menu with the top rated offer 610 to select from. In this example, there are three top rated offers for the product the user 202 identified. These offers include offer 1, offer 2, and offer 3.

The offer interface 600 may also provide the user 202 with his/her frequently requested offers in the your frequently requested offers 612. The user's 202 frequently requested offers are based on the user's 202 offer acceptance history.

In some embodiments, the offers provided to the user 202 via the offer matching program may be based on the user's 202 offer acceptance history. The system may store offers that the user 202 has previously used. The offers may be from the offer matching program or any offers independent of the offer matching program. For example, an advertiser may provide information to the financial institution indicating that a user 202 used a promotion that the advertiser was running independent of the offer matching program. Thus, the system may recognize any offer the user 202 may have used to purchase a product. Offers from the offer catalog may be filtered and provided to the your frequently requested offers section 612 of the offer interface 600 based on the user's 202 offer acceptance history, such that if the user 202 has accepted and/or used an offer to purchased a product the system may recognize this and filter out products that are not found in the user 202 offer acceptance history to provide to the user 202 in the your frequently request offers section 612. In this way, the user 202 may receive offers for products that are the same, similar to, or of the same category of products that the user 202 has accepted an offer for in the past. In the embodiment illustrated in the offer interface 600 of FIG. 7, the user 202 has 9 offers to select from in the your frequently requested offers 612, offers 4 through 12.

Once the user 202 has selected the offers that he/she would like to use by selecting the checkbox located next to the offer, the user 202 may finish by selecting the select offers button 614.

Referring back to FIG. 5, the user 202 may select an offer in the select offer decision block 506. In some embodiments, the user 202 may select an offer via an interface, such as the offer interface 600. In other embodiments, the user 202 may select an offer via other means, such as, but not limited to through the mail, email, text message, voice message, social networking site, an application such as a mobile banking application, the Internet, or the like. In this way, the user 202 may be able to conveniently find and utilize offers provide to him/her via the offer matching program. In some embodiments, if the user 202 does not select an offer in the select offer decision block 508, the system may request the user to provide further identification of the product the user 202 wishes to receive an offer for. In other embodiments, if the user 202 does not select an offer in the select offer decision block 508 no offer is provided to him/her at this time and the offer matching program waits for the user 202 to provide another product identification.

If the user 202 does select a promotional offer from the offers provided to him/her via the offer matching program, the user 202 may then direct the promotional offer where he/she desires, as illustrated in block 510. The offer interface 600, as illustrated in FIG. 7 further provides a means for the user 202 to direct the offers. In section 616 of the offer interface 600 the user 202 is able to direct offers to several locations. The offers may be directed to the user's 202 credit card 618, rewards card 620, the user 202 may be able to print the offer 622, receive the offer via email 624, or receive the offer via the telephone 626. In this way, the offer may be directed to any available median in which an offer may be placed.

If the user 202 selects to provide the offer to his/her credit card 618. The offer matching system may require the user 202 to input his/her credit card information such that the system may be able to input the offer, such as a coupon onto the credit card. In this way, when the user 202 pays for the product at a merchant using his/her credit card, the merchant may be able to recognize the coupon and provide the user 202 with the discount associated with the coupon. In this way, the user 202 does not have to provide paper coupons, etc. to a merchant upon his/her checkout, but instead the system may, upon user 202 request, input the coupon into the user's 202 credit card, such that when the user 202 pays for the product of the coupon with the credit card, the coupon will be applied to that product. The same or similar will occur when the user 202 directs the offer to his/her reward card 620. For example, if the user 202 shops at a merchant who has a merchant rewards card program the user 202 may provide the offer matching system with his/her rewards card information. In this way, the offer matching system may contact the advertiser and include the offer on the user's 202 rewards card. Thereafter, when the user 202 uses his/her rewards card when making a purchase at the merchant providing the rewards card, the merchant may recognize the offer when the rewards card is scanned and provide the user 202 with the discount associated with the offer at that time.

The user 202 may also elect to print the offer 622. In this way, the user 202 may be able to print the offer and provide the offer to an advertiser upon transacting with the advertiser, such as providing a coupon for a product to the advertiser when paying for that product at an advertiser, for example a merchant. The user 202 may also elect to email the offer 624. In this way, the user 202 may provide the offer matching system with his/her email address or another individual's email address in which the user 202 would like to direct the offer to. Thereafter, the user 202 may be able to print the offer from his/her email or present the email to the advertiser to use the offer. The user 202 may also be able to direct the offer to his/her or another individual's phone 262. In this way, the user 202 may add the offer to a mobile application, text message, or the like, such that the offer is on his/her phone and able to be presented to a merchant in that way. Once the user 202 has selected the offer he/she wishes to use and provides a location to direct the offer to, the user 202 may select the finished button on the offer interface 600 to complete the session.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that all computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the all computer-executable program code portions for carrying out operations of embodiments of the present invention are written in conventional procedural programming languages, such as the “C” programming languages and/or similar programming languages. The computer program code may alternatively or additionally be written in all multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by all computer-executable program code portions. These all computer-executable program code portions may be provided to a processor of a general purpose computer, special purpose computer, and/or some other programmable data processing apparatus in order to produce a particular machine, such that the all computer-executable program code portions, which execute via the processor of the computer and/or other programmable data processing apparatus, create mechanisms for implementing the steps and/or functions represented by the flowchart(s) and/or block diagram block(s).

It will also be understood that the all computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The all computer-executable program code portions may also be loaded onto a computer and/or other programmable data processing apparatus to cause a series of operational steps to be performed on the computer and/or other programmable apparatus. In some embodiments, this produces a computer-implemented process such that the all computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for matching offers to a product, the method comprising:
receiving an indication from a user that the user requests a promotional offer for a product;
determining, based on the indication from the user, an identification of the product the user is requesting the offer for, wherein the product is identified based at least in part on a matching of characteristics of the product with characteristics of a known product in a database;
matching, via a computer device processor, the identified product with offers available for products in a category of product associated with the identified product;
filtering the offers based on pre-established rules; and
directing the offers to the user based at least in part on a received indication from the user.

2. The method of claim 1 further comprising processing the indication from the user to determine the product associated with the indication.

3. The method of claim 2, wherein processing the indication from the user to determine the product associated with the indication further comprises determining product characteristics associated with the product associated with the indication, such that a product may be identified by the product characteristics.

4. The method of claim 3, wherein product characteristics further comprise packaging of the product.

5. The method of claim 3, wherein product characteristics further comprise logos associated with the product.

6. The method of claim 1, wherein pre-established rules provide indications as to which user may receive the promotional offer based on the user's transaction history with an entity providing the product.

7. The method of claim 1, wherein the indication from the user that the user requests an offer for a product is a scanned bar code.

8. The method of claim 1, wherein the indication from the user that the user requests an offer for a product is a keyword associated with the product.

9. The method of claim 1, wherein the indication from the user that the user requests an offer for a product is a product number associated with the product.

10. The method of claim 1, wherein the indication from the user that the user requests an offer for a product an image of the product.

11. The method of claim 1, wherein the offer for the product is a coupon for the product.

12. The method of claim 1, wherein the offer for the product is directed to the user through a user application.

13. The method of claim 1 further comprising matching the identified product with offers available for the identified product.

14. A system for matching offers to a product, the system comprising:
a memory device;
a communication device; and
a processing device operatively coupled to the memory device and the communication device, wherein the processing device is configured to execute computer-readable program code to:
receive an indication from a user that the user requests a promotional offer for a product;
determine, based on the indication from the user, an identification of the product the user is requesting the offer for, wherein the product is identified based at least in part on a matching of characteristics of the product with characteristics of a known product in a database;
match the identified product with offers available for products in a category of product associated with the identified product;
filter the offers based on pre-established rules; and
direct the offers to the user based at least in part on a received indication from the user.

15. The system of claim 14, wherein the processing device is further configured to process the indication from the user to determine the product associated with the indication.

16. The system of claim 15, wherein processing the indication from the user to determine the product associated with the indication further comprises determining product characteristics associated with the product associated with the indication, such that a product may be identified by the product characteristics.

17. The system of claim 16, wherein product characteristics further comprise packaging of the product.

18. The system of claim 16, wherein product characteristics further comprise logos associated with the product.

19. The system of claim 14, wherein pre-established rules provide indications as to which user may receive the promotional offer based on the user's transaction history with an entity providing the product.

20. The system of claim 14, wherein the indication from the user that the user requests an offer for a product is a scanned bar code.

21. The system of claim 14, wherein the indication from the user that the user requests an offer for a product is a keyword associated with the product.

22. The system of claim 14, wherein the indication from the user that the user requests an offer for a product is a product number associated with the product.

23. The system of claim 14, wherein the indication from the user that the user requests an offer for a product an image of the product.

24. The system of claim 14, wherein the offer for the product is a coupon for the product.

25. The system of claim 14, wherein the offer for the product is directed to the user through a user application.

26. The system of claim 14, wherein the processing device is further configured to match the identified product with offers available for the identified product.

27. A computer program product for matching promotional offers to a product, the computer program product comprising at least one non-transitory computer-readable medium having computer-readable program code portions embodied therein, the computer-readable program code portions comprising:
an executable portion configured for receiving an indication from a user that the user requests a promotional offer for a product;
an executable portion configured for determining, based on the indication from the user, an identification of the product the user is requesting the offer for, wherein the product is identified based at least in part on a matching of characteristics of the product with characteristics of a known product in a database;
an executable portion configured for matching the identified product with offers available for products in a same category of products as the identified product;
an executable portion configured for filtering the offers based on pre-established rules; and
an executable portion configured for directing the offers to the user based at least in part on a received indication from the user.

28. The computer program product of claim 27 further comprising an executable portion configured for processing the indication from the user to determine the product associated with the indication.

29. The computer program product of claim 28, wherein processing the indication from the user to determine the product associated with the indication further comprises determining product characteristics associated with the product associated with the indication, such that a product may be identified by the product characteristics.

30. The computer program product of claim 29, wherein product characteristics further comprise packaging of the product.

31. The computer program product of claim 29, wherein product characteristics further comprise logos associated with the product.

32. The computer program product of claim 27, wherein pre-established rules provide indications as to which user may receive the promotional offer based on the user's transaction history with an entity providing the product.

33. The computer program product of claim 27, wherein the indication from the user that the user requests an offer for a product is a scanned bar code.

34. The computer program product of claim 27, wherein the indication from the user that the user requests an offer for a product is a keyword associated with the product.

35. The computer program product of claim 27, wherein the indication from the user that the user requests an offer for a product is a product number associated with the product.

36. The computer program product of claim 27, wherein the indication from the user that the user requests an offer for a product an image of the product.

37. The computer program product of claim 27, wherein the offer for the product is a coupon for the product.

38. The computer program product of claim 27, wherein the offer for the product is directed to the user through a user application.

39. The computer program product of claim 27 further comprising an executable portion configured to match the identified product with offers available for the identified product.
